(19) United States
(12) Patent Application Publication
(10) Pub. No.: US 2026/0331007 A1
(43) Pub. Date: Oct. 22, 2026

(54) SYSTEMS AND METHODS FOR MOBILE VEHICLE ADVERTISING

(71) Applicant: AIM Advertising in Motion, LLC, Skokie, IL (US)

(72) Inventor: Evan Polak, Skokie, IL (US)

(21) Appl. No.: 19/654,075

(22) Filed: Apr. 21, 2026

Related U.S. Application Data
(60) Provisional application No. 63/792,545, filed on Apr. 22, 2025.

(51) Int. Cl. G09F 21/04

(52) U.S. Cl. CPC G09F 21/0485

(57) ABSTRACT

A system includes a vehicle comprising a rear windshield and an odometer. A perforated window film covers an outer surface of the rear windshield, wherein the perforated window film comprises 50% printable area and 50% open area. A mobile application is configured to prompt a driver of the vehicle to take a photo of the rear windshield and the odometer at a predetermined interval. The mobile application is configured to continuously track a location of the driver relative to a designated address. The mobile application is configured to calculate total miles within a radial zone of the designated address based on the tracked location of the driver. The mobile application is configured to calculate a payment amount based on the calculated total miles within the radial zone multiplied by a predetermined rate.

### CROSS-REFERENCE TO RELATED APPLICATIONS

This application claims the benefit of U.S. Provisional Application No. 63/792,545, filed Apr. 22, 2025, which is hereby incorporated by reference in its entirety.

### FIELD OF INVENTION

The present disclosure relates to mobile advertising systems, and more particularly to systems and methods for connecting advertisers with vehicle drivers through a mobile application platform that tracks driver location and mileage to facilitate vehicle-based advertising campaigns.

### BACKGROUND

Advertising is a fundamental component of modern commerce, enabling businesses to reach potential customers and build brand awareness. For local businesses in particular, establishing connections with the surrounding community can be a significant factor in driving customer engagement and foot traffic. Traditional advertising methods, such as billboards, print media, and digital advertisements, offer various approaches for businesses to communicate their messages to consumers.

Vehicle-based advertising has emerged as an alternative form of out-of-home advertising. By displaying advertisements on vehicles, businesses may reach consumers in various locations as the vehicles travel through different areas. Studies have suggested that mobile advertisements on vehicles may achieve higher message recall rates compared to certain stationary advertising formats. The rear window of a vehicle, in particular, may be visible to other drivers and pedestrians during normal driving conditions.

However, existing vehicle advertising arrangements may present various challenges. Full vehicle wraps can be visually prominent and may not appeal to all vehicle owners. Additionally, coordinating between advertisers seeking exposure in specific geographic areas and drivers who regularly travel through those areas can be logistically complex. Tracking and verifying the actual exposure generated by vehicle-based advertisements, as well as compensating drivers fairly based on their driving activity, may also present difficulties.

Furthermore, many individuals spend considerable time driving each day as part of their regular routines, such as commuting to work or running errands. This driving time represents a potential opportunity for drivers to participate in advertising programs, though existing systems may not fully leverage location-based data to optimize the value of vehicle advertising for both advertisers and drivers.

Therefore, there remains a need for improved systems and methods that address one or more of these considerations in the field of mobile vehicle advertising.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system is provided. The system includes a vehicle comprising a rear windshield and an odometer. The system includes a perforated window film covering an outer surface of the rear windshield, wherein the perforated window film comprises 50% printable area and 50% open area. The system includes a mobile application configured to prompt a driver of the vehicle to take a photo of the rear windshield and the odometer at a predetermined interval. The mobile application is configured to continuously track a location of the driver relative to a designated address. The mobile application is configured to calculate total miles within a radial zone of the designated address based on the tracked location of the driver. The mobile application is configured to calculate a payment amount based on the calculated total miles within the radial zone multiplied by a predetermined rate.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates multiple radial zones used to calculate an amount paid to a driver, according to aspects of the present disclosure.

FIG. 2 illustrates a history page of a mobile application interface, according to aspects of the present disclosure.

FIG. 3 illustrates a home page of the mobile application interface at the beginning of a trip, according to aspects of the present disclosure.

FIG. 4 illustrates the home page of the mobile application interface at the end of a trip, according to aspects of the present disclosure.

FIG. 5 illustrates a perforated window film on a rear windshield of a vehicle, according to aspects of the present disclosure.

FIG. 6A illustrates a perforated window film with 65% printable area and 35% open area, according to aspects of the present disclosure.

FIG. 6B illustrates a perforated window film with 50% printable area and 50% open area, according to aspects of the present disclosure.

FIG. 7 illustrates an example advertisement for use with the system and method, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure describes a mobile vehicle advertising system that connects advertisers with vehicle drivers through a mobile application platform. The mobile vehicle advertising system may facilitate vehicle-based advertising campaigns by tracking driver location and mileage to enable targeted advertising exposure and driver compensation.

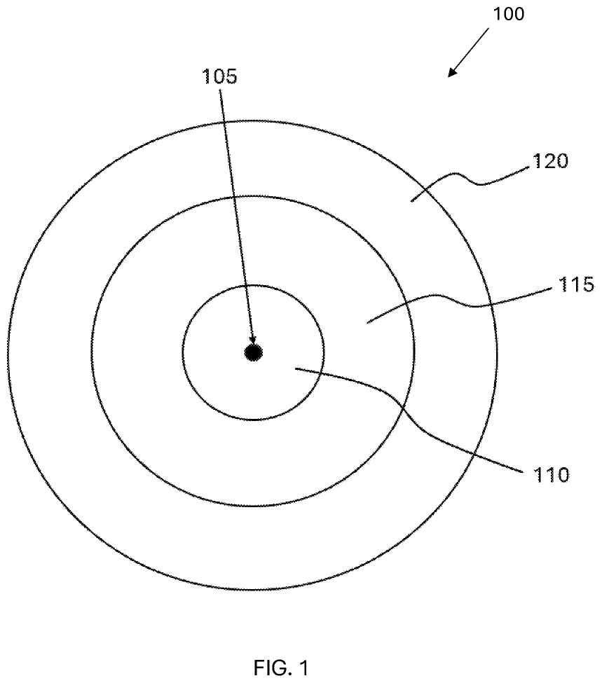

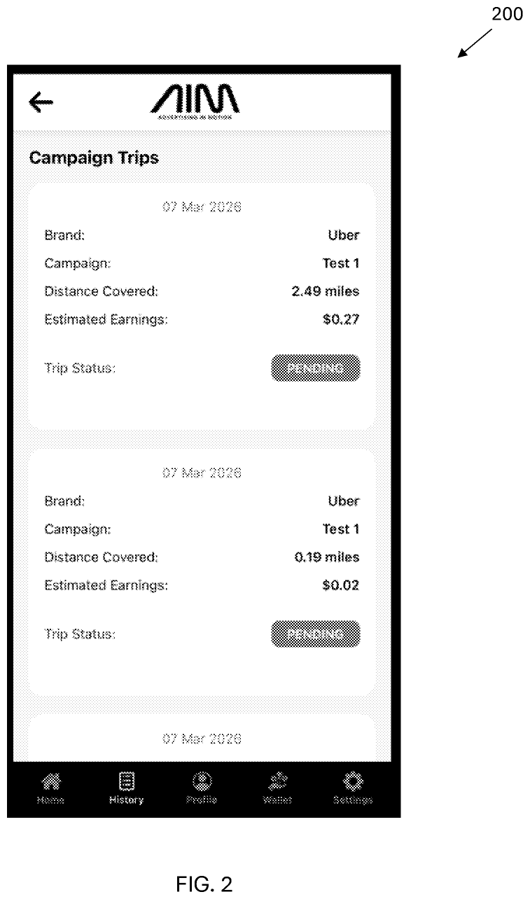

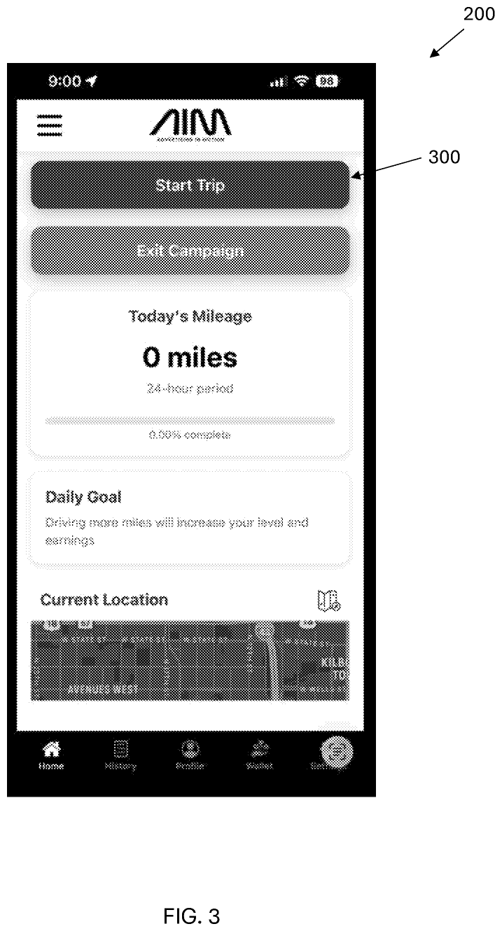

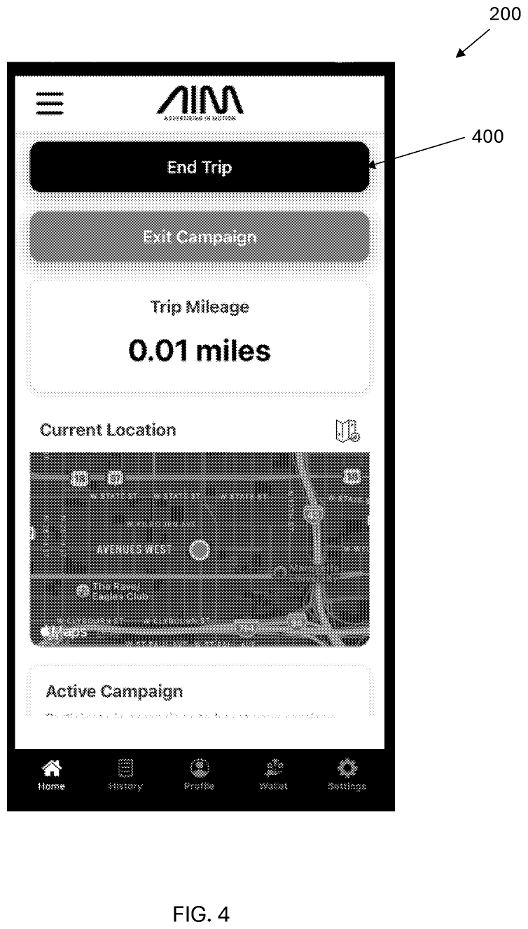

In some aspects, and referring to FIGS. 1-6, the mobile vehicle advertising system includes a vehicle 500 having a rear windshield 510 and an odometer, a perforated window film 505 applied to the rear windshield, and a mobile application 200. The mobile application 200 may be configured to track the location of a driver relative to one or more designated addresses associated with advertisers. The mobile application 200 may calculate miles driven within defined radial zones around the designated addresses and determine payment amounts for drivers based on the calculated mileage.

The mobile vehicle advertising system may provide local businesses with an opportunity to advertise to a community by leveraging drivers who regularly travel through areas near the businesses. The system may connect advertisers seeking exposure in specific geographic areas with drivers who want to earn supplemental income through driving activities the drivers already perform as part of daily routines, such as commuting to work or running errands.

In some cases, the mobile application may continuously track the location of the driver and calculate total miles driven within one or more radial zones surrounding a designated address. The mobile application may calculate a payment amount based on the total miles driven within the radial zones multiplied by a predetermined rate. Different predetermined rates may apply to different radial zones, such that miles driven closer to a designated address may be compensated at a different rate than miles driven farther from the designated address.

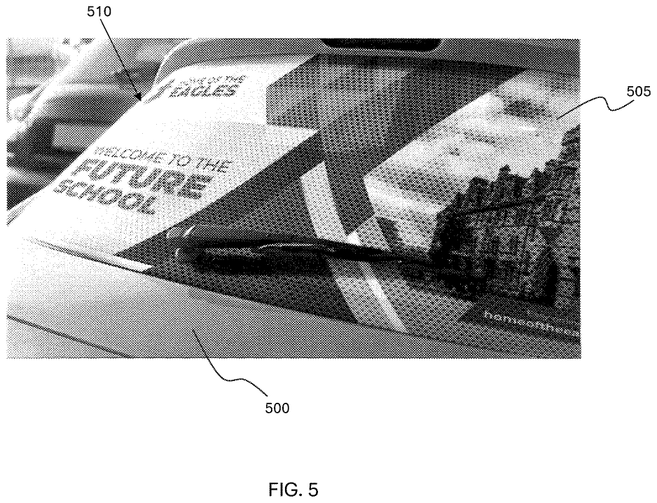

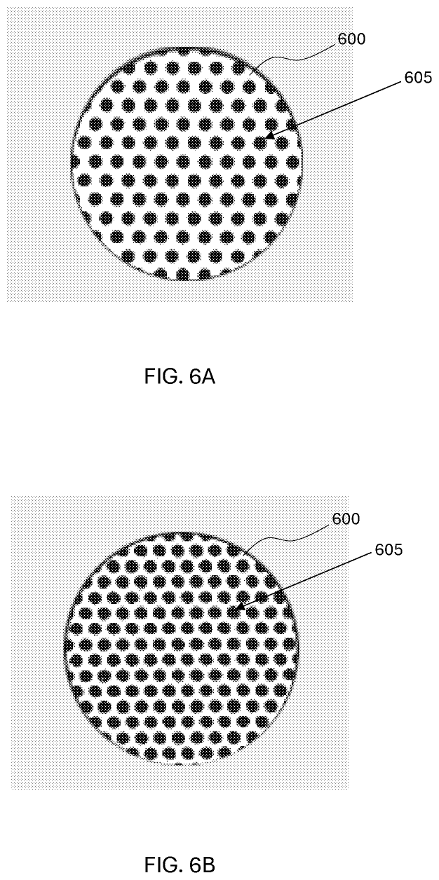

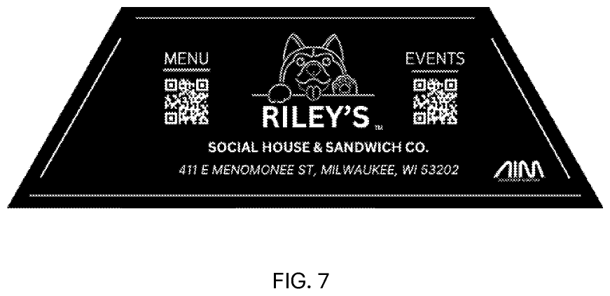

In various embodiments, and referring to FIGS. 5, 6A and 6B, the mobile vehicle advertising system may utilize a perforated window film 505 applied to the rear windshield 510 of the vehicle 500. The perforated window film 505 may include a printable area for displaying an advertisement and an open area 605 that allows visibility through the rear windshield 510. In some aspects, the perforated window film 505 may include 50% printable area and 50% open area 605. For example, and referring to FIG. 7, the advertisement printed on the perforated window film 505 may include information about a local business, and in some cases, the advertisement may include a QR code that allows viewers to access additional information about the business.

The mobile application 200 may prompt the driver to take photos of the rear windshield 510 and the odometer at predetermined intervals, such as weekly or monthly intervals. The photo verification may allow the system to confirm that the perforated window film 505 remains intact and presentable on the vehicle 500. The mobile application 200 may also display a dashboard showing mileage information, payment information, and a map indicating the designated address and associated radial zones.

The mobile vehicle advertising system may include a vehicle 500 having a rear windshield 510 and an odometer. The rear windshield 510 may serve as the physical platform for displaying advertisements to other drivers and pedestrians. The rear windshield 510 may be positioned at the back of the vehicle 500 and may be visible to individuals traveling behind the vehicle 500 or observing the vehicle from various angles. In some aspects, the rear windshield 510 may provide a viewing surface that is frequently observed by other road users during normal driving conditions.

The odometer of the vehicle 500 may provide mileage information used for verification and compensation purposes within the mobile vehicle advertising system. The odometer may record the total distance traveled by the vehicle 500. In some cases, the mobile application 200 may prompt the driver to capture a photo of the odometer at predetermined intervals to verify the mileage driven by the vehicle 500. The odometer reading may be used in conjunction with location tracking data to confirm driving activity within designated radial zones.

In some aspects, the vehicle 500 may be a registered vehicle that meets certain condition requirements. The vehicle 500 may be in overall good condition without dents or scratches that may affect or distort an advertisement displayed on the rear windshield 510. The exterior condition of the vehicle 500 may contribute to the presentation quality of the advertisement displayed on the perforated window film 505 applied to the rear windshield 510.

The rear windshield 510 and the odometer may function together within the mobile vehicle advertising system to provide both the advertising display surface and the mileage verification mechanism. The rear windshield 510 may receive a perforated window film 505 that displays an advertisement, while the odometer may provide data used to calculate driver compensation based on miles driven within designated geographic areas. In some cases, the mobile application 200 may prompt the driver to photograph both the rear windshield 510 and the odometer at predetermined intervals to verify that the perforated window film 505 remains intact and presentable and to confirm the mileage recorded by the vehicle 500.

The mobile vehicle advertising system may include a perforated window film 505 applied to an outer surface of a rear windshield 510 of a vehicle 500. The perforated window film 505 may include a printable area 600 and an open area 605 (i.e., holes within the window film 505). The printable area 600 may provide a surface on which an advertisement may be printed, while the open area 605 may allow visibility through the rear windshield 510 from inside the vehicle 500.

In some aspects, the perforated window film 505 may include 50% printable area 600 and 50% open area 605, as illustrated in FIG. 6B. In some cases, the perforated window film 505 may include 65% printable area 600 and 35% open area 605, as illustrated in FIG. 6A. The ratio of printable area 600 to open area 605 may be selected based on visibility requirements and advertising display considerations.

The printable area 600 of the perforated window film 505 may receive an advertisement printed thereon, for example as illustrated in FIG. 7. The advertisement may include information about a local business, such as a business name, logo, contact information, or promotional messaging. In some cases, the advertisement may include a QR code that allows viewers to access additional information about the business. The QR code may be scannable by individuals observing the vehicle 500 when the vehicle 500 is parked, enabling viewers to obtain further details about the advertised business through a mobile device.

The perforated window film 505 may utilize a simplistic design that maintains the aesthetics of the vehicle 500. The simplistic design may address concerns associated with full vehicle wraps, which may be visually prominent and attention-grabbing. By limiting the advertisement to the rear windshield 510 rather than covering the entire vehicle 500, the perforated window film 505 may preserve the overall appearance of the vehicle 500 while still providing advertising exposure.

In some aspects, the perforated window film 505 may include a tracking puck embedded in the film. The tracking puck may be a plastic component that emits a signal to assist the mobile application 200 in tracking mileage of the vehicle 500. A graphics installer may apply the tracking puck during installation of the perforated window film 505 on the rear windshield 510. The signal emitted by the tracking puck may be received by the mobile application 200 to supplement location tracking data and verify driving activity.

Prior to installation of the perforated window film 505, the vehicle 500 may undergo a car wash. The pre-installation car wash may remove dirt and debris from the rear windshield 510 to prevent dirt and debris from becoming trapped between the perforated window film 505 and the rear windshield 510. Washing the vehicle 500 thoroughly before installation may promote proper adhesion of the perforated window film 505 and may maintain the visual quality of the advertisement displayed on the printable area 600.

The mobile vehicle advertising system may include a mobile application 200 configured to facilitate communication between drivers and the system. The mobile application 200 may be stored on a non-transitory computer-readable medium and may be executable by a processor of a mobile device, such as a smartphone or tablet. In some aspects, the mobile application 200 may require enabling of location services, motion and fitness tracking, and notifications on the mobile device to provide full functionality within the mobile vehicle advertising system.

The mobile application 200 may include a home page displaying a “start trip” button 300. At the beginning of each trip associated with a particular campaign, the driver presses the “start trip” button 300. Pressing the “start trip” button 300 may enable GPS and tracking functionality on the mobile device. Upon completion of the trip, the driver presses an “end trip” button 400 to conclude the tracking session for that particular trip.

The mobile application 200 may include a photo verification feature configured to prompt a driver of a vehicle 500 to take a photo of a rear windshield and an odometer of the vehicle 500 at a predetermined interval. The predetermined interval may include a weekly interval or a monthly interval. In some cases, the photo verification feature may prompt the driver to capture images at other intervals based on system requirements or advertiser preferences. In some aspects, the mobile application 200 may prompt the driver to take a photo of a rear windshield and an odometer of the vehicle 500 when the driver initiates a trip by pressing the “start trip” button 300 on the mobile application 200.

The photo verification feature may allow the mobile vehicle advertising system to confirm that a perforated window film 505 applied to the rear windshield remains intact and presentable. By prompting the driver to photograph the rear windshield at predetermined intervals, the mobile application 200 may enable verification that the advertisement displayed on the perforated window film 505 has not been damaged, removed, or otherwise compromised. The photo verification may also allow the system to confirm that the perforated window film 505 maintains visual quality suitable for advertising purposes.

In some aspects, the mobile application 200 may prompt the driver to photograph the odometer of the vehicle 500 in addition to the rear windshield. The odometer photograph may provide mileage verification data that supplements location tracking information collected by the mobile application 200. The odometer reading captured in the photograph may be compared against mileage data calculated from location tracking to verify driving activity within designated radial zones.

The photo verification feature may operate by generating a notification on the mobile device at the predetermined interval or when a new trip is started/initiated. The notification may prompt the driver to open the mobile application 200 and capture the requested photographs. In some cases, the mobile application 200 may provide instructions or guidance to the driver regarding how to capture photographs that clearly show the rear windshield with the perforated window film 505 and the odometer reading.

The photographs captured through the photo verification feature may be transmitted to a server or backend system for review. In some aspects, the photographs may be reviewed to assess the condition of the perforated window film 505 and to extract the odometer reading for mileage verification purposes. The photo verification process may help maintain advertising quality standards by identifying instances where the perforated window film 505 may require replacement or repair.

The mobile application 200 may store a history of photo verifications completed by the driver. In some cases, the mobile application 200 may display a status indicator showing whether the driver has completed the most recent photo verification request. The photo verification history may be accessible to the driver through the mobile application 200 interface and may also be accessible to system administrators for quality assurance purposes.

The mobile application 200 may include a location tracking feature configured to continuously track a location of a driver relative to a designated address. The designated address may correspond to a location associated with an advertiser, such as a business address of a local business that has engaged the mobile vehicle advertising system to display an advertisement on a perforated window film 505 applied to a rear windshield of a vehicle 500. In some aspects, the mobile application 200 may track the location of the driver using location services enabled on a mobile device on which the mobile application 200 is installed.

The location tracking feature may utilize global positioning system (GPS) data, cellular network data, Wi-Fi positioning data, or a combination thereof to determine the location of the driver. In some cases, the mobile application 200 may require enabling of location services on the mobile device to provide location tracking functionality. The mobile application 200 may continuously monitor the location of the driver while the mobile application 200 is running on the mobile device.

The mobile vehicle advertising system may include a radial zone system configured to define geographic areas surrounding the designated address. The radial zone system may include a first radial zone 110 having a first radius from the designated address. The first radial zone 110 may define a geographic area closest to the designated address. Miles driven by the driver within the first radial zone may be tracked and recorded by the mobile application 200.

In some aspects, the radial zone system may include a second radial zone 115 having a second radius from the designated address. The second radius may be greater than the first radius. The second radial zone 115 may define a geographic area that extends beyond the first radial zone 110. The second radial zone 115 may define an annular region between the first radius and the second radius. Miles driven by the driver within the second radial zone 115 may be tracked and recorded separately from miles driven within the first radial zone 110.

In some cases, the radial zone system may include a third radial zone 120 having a third radius from the designated address. The third radius may be greater than the second radius. The third radial zone 120 may define a geographic area that extends beyond the second radial zone 115. The third radial zone 120 may define an annular region between the second radius and the third radius. Miles driven by the driver within the third radial zone 120 may be tracked and recorded separately from miles driven within the first radial zone 110 and the second radial zone 115.

The mobile application 200 may calculate total miles driven within each radial zone based on the tracked location of the driver. The mobile application 200 may determine when the driver enters and exits each radial zone and may accumulate mileage data for each radial zone accordingly. In some aspects, the mobile application 200 may calculate total miles within the first radial zone, total miles within the second radial zone, and total miles within the third radial zone as separate values.

The radial zone system may allow the mobile vehicle advertising system to differentiate between miles driven at different distances from the designated address. Miles driven closer to the designated address may provide different advertising value compared to miles driven farther from the designated address. For example, miles driven in the first radial zone 110 may provide the highest pay rate compared to the pay rates for the second and third radial zones 115, 120. Similarly, the miles driven in the second radial zone 115 may provide a higher pay rate relative to the pay rate for the third radial zone 120, but a lower pay rate relative to the pay rate for first radial zone 110. Finally, the third radial zone 120 may provide the lowest pay rate relative to the pay rates for first and second radial zones 110, 115.

The mobile application 200 may display a map showing the designated address and the radial zones, as illustrated in FIG. 1. The map may visually indicate the boundaries of the first radial zone, the second radial zone, and the third radial zone relative to the designated address. In some aspects, the map may display the current location of the driver relative to the radial zones. The map may allow the driver to visualize geographic areas where driving activity contributes to mileage calculations for payment purposes.

In some cases, the mobile application 200 may include heat zones that indicate boosted areas or bonus pay regions. The heat zones may correspond to areas where driving activity may generate increased compensation for the driver. The mobile application 200 may display notifications or indicators to inform the driver when the driver enters a heat zone or a boosted area.

The mobile application 200 may calculate a payment amount based on the calculated total miles within the radial zone multiplied by a predetermined rate. The mobile application 200 may determine the total miles driven by the driver within each radial zone and apply the corresponding predetermined rate to calculate the payment amount owed to the driver.

In some aspects, the mobile application 200 may calculate the payment amount based on different predetermined rates for miles driven within the first radial zone, the second radial zone, and the third radial zone. The predetermined rate applied to miles driven within the first radial zone may differ from the predetermined rate applied to miles driven within the second radial zone. Similarly, the predetermined rate applied to miles driven within the second radial zone may differ from the predetermined rate applied to miles driven within the third radial zone. The mobile application 200 may multiply the total miles driven within each radial zone by the respective predetermined rate and sum the resulting values to calculate the total payment amount. For example, the rate for miles driven within the first radial zone 110 may be $0.25, the rate for miles driven in the second radial zone 115 may be $0.20, and the rate for miles driven in the third radial zone 120 may be $0.15. Miles driven outside of the third radial zone 120 may not receive any compensation.

The mobile vehicle advertising system may utilize a revenue split model for distributing payments between drivers and the system operator. In some cases, for every one dollar per mile charged to an advertiser, the driver may receive forty cents and the system operator may receive sixty cents. The revenue split model may provide a framework for compensating drivers based on the advertising revenue generated through driving activity within the designated radial zones.

The mobile application 200 may apply boosted pay rates in designated boosted zones or heat zones. In some aspects, the boosted pay rate may range from thirty cents to thirty-two cents per mile when the driver operates within a boosted zone. The standard predetermined rate outside of boosted zones may be twenty-one cents per mile. The mobile application 200 may detect when the driver enters a boosted zone and apply the boosted pay rate to miles driven within the boosted zone.

The mobile vehicle advertising system may process payments to drivers through direct deposit. In some cases, the driver may link a bank account to the mobile application 200 to receive payment amounts calculated by the mobile application 200. The mobile application 200 may transmit payment information to a payment processing system that initiates direct deposit transfers to the linked bank account of the driver. The direct deposit payment processing may occur at predetermined intervals, such as weekly or monthly intervals, based on the accumulated payment amounts calculated from miles driven within the radial zones.

The mobile application 200 may include a mobile application 200 interface comprising a dashboard. The dashboard may display mileage information and payment information for the driver. The mileage information may include total miles driven within each radial zone, and the payment information may include accumulated earnings and payment history. The dashboard may provide the driver with a summary of driving activity and compensation within the mobile vehicle advertising system.

The mobile application 200 may be configured to display a map showing the designated address and the radial zone. The map may visually indicate the boundaries of the radial zones relative to the designated address. In some aspects, the map may display the current location of the driver relative to the radial zones. The map may allow the driver to visualize geographic areas where driving activity contributes to mileage calculations for payment purposes.

The mobile application 200 may display heat zones indicating boosted areas where drivers may earn bonus pay for driving in those locations. The heat zones may correspond to geographic regions where driving activity generates increased compensation for the driver. In some cases, the mobile application 200 may display notifications or indicators to inform the driver when the driver enters a heat zone or a boosted area. The boosted areas may provide higher pay rates compared to standard rates applied outside of the heat zones.

The mobile application 200 may include a gamified experience with leveling progress where drivers may level up based on driving activity within the mobile vehicle advertising system. The leveling progress may track driver participation and performance over time. In some aspects, higher levels may result in higher wages for the driver. The gamified experience may encourage driver engagement by providing progression-based incentives tied to compensation rates.

The mobile application 200 may include scanning accessibility for activation of a driver account. The scanning feature may allow the driver to activate the driver account within the mobile application 200 by scanning a code or identifier associated with the perforated window film 505 or the mobile vehicle advertising system. In some cases, the scanning accessibility feature may verify that the driver has received and installed the perforated window film 505 on the rear windshield of the vehicle 500.

The mobile application 200 may include a profile section for driver account management. The profile section may display driver information and account details. The mobile application 200 may also include a settings menu that allows the driver to configure preferences and account options within the mobile application 200. In some aspects, the settings menu may include options for managing notifications, location services, and other mobile application features.

The mobile application 200 may be configured to display notifications comprising driving tips for the driver. The notifications may include tips for drivers to increase earnings within the mobile vehicle advertising system. In some cases, the notifications may inform the driver of times or locations where driving activity may generate increased compensation. The driving tips may include suggestions regarding when to drive or which areas to travel through to maximize mileage within the radial zones or heat zones.

The mobile application 200 may include a payment feature where the driver enters bank account information for direct deposit. The driver may link a bank account to the mobile application 200 to receive payment amounts calculated by the mobile application 200. In some aspects, the mobile application 200 may transmit payment information to a payment processing system that initiates direct deposit transfers to the linked bank account of the driver. The direct deposit payment processing may occur at predetermined intervals based on the accumulated payment amounts calculated from miles driven within the radial zones.

The mobile vehicle advertising system may include a company dashboard accessible to advertisers through the mobile application 200. The company dashboard may provide advertisers with tools for managing logistics associated with advertising campaigns. In some aspects, the company dashboard may allow advertisers to view analytics related to advertising campaign performance. The company dashboard may display total impressions generated by vehicles displaying advertisements associated with the advertiser.

The mobile application 200 may display campaign information for advertisers through the company dashboard. The campaign information may include spent amounts indicating the total expenditure for an advertising campaign. The campaign information may include impressions data representing the number of times an advertisement has been viewed by individuals. In some cases, the campaign information may include clicks data indicating the number of interactions generated by an advertisement, such as scans of a QR code displayed on a perforated window film 505. The campaign information may include cost per impression data that represents the cost incurred by the advertiser for each impression generated by the advertising campaign. The cost per impression data may allow advertisers to evaluate the efficiency of advertising expenditures relative to the exposure achieved.

The mobile vehicle advertising system may utilize artificial intelligence (AI) to analyze foot traffic patterns. The AI may process data related to pedestrian and vehicle traffic in geographic areas surrounding designated addresses associated with advertisers. In some aspects, the AI may identify patterns in foot traffic that indicate times or locations where advertising exposure may reach larger audiences. The AI may analyze rush hour timing to determine periods when vehicle traffic density increases, such as during commuting hours when drivers travel to and from work. The analysis of rush hour timing may allow the mobile vehicle advertising system to optimize advertising effectiveness by identifying time periods when advertisements displayed on vehicles may be viewed by increased numbers of individuals. In some cases, the AI may generate recommendations or insights for advertisers based on the analyzed foot traffic patterns and rush hour timing data.

The mobile vehicle advertising system may include driver qualification requirements that drivers may satisfy before participating in advertising campaigns. In some aspects, the mobile vehicle advertising system may require drivers to be at least 21 years old to participate in the advertising program. The minimum age requirement may allow the mobile vehicle advertising system to verify that drivers meet a baseline maturity and experience level for operating a vehicle while participating in the advertising program.

In some cases, the mobile vehicle advertising system may require drivers to pass a background check before participating in the advertising program. The background check may include a review of the driving history of the driver to verify that the driver has a clean driving record. The background check may allow the mobile vehicle advertising system to assess driver eligibility based on driving history and other relevant factors.

The mobile vehicle advertising system may include vehicle requirements that drivers may satisfy to participate in advertising campaigns. In some aspects, the mobile vehicle advertising system may require drivers to have a registered vehicle from 2010 or newer. The vehicle age requirement may allow the mobile vehicle advertising system to maintain a fleet of vehicles that present advertisements on vehicles with a certain level of visual appeal. In some cases, the mobile vehicle advertising system may require the registered vehicle to have no more than 85,000 miles on the odometer. The mileage requirement may allow the mobile vehicle advertising system to verify that vehicles participating in the advertising program are within a certain mileage range.

The mobile vehicle advertising system may include an initial qualification driving requirement for drivers before the drivers qualify for advertising campaigns. In some aspects, after signing up for the mobile application 200 and passing the background check, the driver may drive at least 50 miles along a usual commute route of the driver with the mobile application 200 running on a mobile device. The initial qualification driving requirement may allow the mobile vehicle advertising system to collect location data and driving pattern information for the driver before matching the driver with advertising campaigns. Once the driver completes the initial qualification driving requirement, the driver may start qualifying for campaigns and offers within the geographic area where the driver regularly travels.

The mobile vehicle advertising system may include a minimum monthly mileage requirement for drivers participating in advertising campaigns. In some aspects, the mobile vehicle advertising system may require drivers to drive a minimum of 900 miles per month to participate in the advertising program. The minimum monthly mileage requirement may allow the mobile vehicle advertising system to verify that drivers provide a certain level of advertising exposure through regular driving activity.

The mobile vehicle advertising system may include a sticker commitment period during which drivers agree to display the perforated window film 505 on the rear windshield 510 of the vehicle 500. In some aspects, the mobile vehicle advertising system may require drivers to commit to having the perforated window film 505 on the vehicle 500 for a period ranging from 6 months to 24 months. The sticker commitment period may allow advertisers to receive sustained advertising exposure over an extended duration through the vehicles participating in the advertising program.

In some aspects, the mobile vehicle advertising system may calculate payment amounts based on population density data in addition to mileage data. The mobile application 200 may determine population density values for geographic areas through which the driver travels. Areas with higher population density may correspond to higher compensation rates for the driver. The mobile application 200 may apply different payment rates based on the population density of the area where the driving activity occurs, such that miles driven in more crowded areas may generate higher compensation compared to miles driven in less crowded areas.

The mobile application 200 may access population density data from a database or external data source. The population density data may include information regarding the number of individuals residing in or frequenting particular geographic regions. In some cases, the mobile application 200 may correlate location tracking data with population density data to determine the population density of areas traversed by the driver during driving activity.

In some aspects, the mobile application 200 may calculate a population density factor for each segment of a trip based on the geographic location of the segment. The population density factor may be applied as a multiplier to the base mileage rate to determine the compensation amount for the segment. Segments driven through areas with higher population density may receive a higher population density factor, resulting in increased compensation for the driver.

The population density-based compensation approach may differ from conventional mileage-only tracking approaches. Conventional approaches may calculate driver compensation based solely on the total distance traveled by the vehicle, without regard to the characteristics of the areas through which the vehicle travels. The mobile vehicle advertising system may account for the advertising exposure value associated with driving through areas where more individuals may view the advertisement displayed on the perforated window film 505. By incorporating population density into the compensation calculation, the mobile vehicle advertising system may align driver compensation with the potential advertising reach achieved during driving activity.

In some cases, the mobile application 200 may combine population density-based compensation with the radial zone system. The mobile application 200 may apply both a radial zone rate based on proximity to a designated address and a population density adjustment based on the crowdedness of the area. The combination of radial zone rates and population density adjustments may provide a compensation structure that accounts for both geographic proximity to the advertiser and the potential audience size in the areas traversed by the driver.

The mobile vehicle advertising system may integrate a vehicle 500, a perforated window film 505, and a mobile application 200 to connect advertisers with drivers and facilitate vehicle-based advertising campaigns. The integration of the vehicle 500, the perforated window film 505, and the mobile application 200 may enable location-based tracking, mileage calculation, and payment processing for drivers participating in advertising programs.

In some aspects, the mobile vehicle advertising system may operate through a driver onboarding process. A driver may download the mobile application 200 onto a mobile device, such as a smartphone or tablet. The driver may create a driver account within the mobile application 200 and provide driver information, including a valid driver's license, vehicle registration information, and insurance information. The mobile application 200 may require the driver to enable location services, motion and fitness tracking, and notifications on the mobile device to provide full functionality within the mobile vehicle advertising system.

The mobile vehicle advertising system may include a background check process for drivers. The driver may submit information for a background check that includes a review of the driving history of the driver. The background check may verify that the driver has a clean driving record and meets driver qualification requirements. In some cases, the mobile vehicle advertising system may require drivers to be at least 21 years old to participate in the advertising program.

The mobile vehicle advertising system may include vehicle qualification requirements. The driver may provide vehicle 500 information including make, model, and year of registration. In some aspects, the mobile vehicle advertising system may require the vehicle 500 to be a registered vehicle from 2010 or newer. The mobile vehicle advertising system may require the vehicle to have no more than 85,000 miles on the odometer. The vehicle may be in overall good condition without dents or scratches that may affect or distort an advertisement displayed on the rear windshield 510.

After the driver completes the background check and vehicle qualification process, the mobile vehicle advertising system may include an initial qualification driving requirement. The driver may drive at least 50 miles along a usual commute route of the driver with the mobile application 200 running on the mobile device. The initial qualification driving requirement may allow the mobile vehicle advertising system to collect location data and driving pattern information for the driver. The mobile application 200 may track the location of the driver during the initial qualification driving period to identify geographic areas where the driver regularly travels.

Once the driver completes the initial qualification driving requirement, the mobile vehicle advertising system may match the driver with advertising campaigns based on the geographic areas where the driver regularly travels. The mobile application 200 may display available campaigns and offers within the geographic area of the driver. The driver may accept an advertising campaign through the mobile application 200.

The mobile vehicle advertising system may include a perforated window film 505 installation process. Prior to installation of the perforated window film 505, the vehicle 500 may undergo a car wash. The pre-installation car wash may remove dirt and debris from the rear windshield 510 to prevent dirt and debris from becoming trapped between the perforated window film 505 and the rear windshield 510. A graphics installer may apply the perforated window film 505 to an outer surface of the rear windshield 510 of the vehicle 500. The perforated window film 505 may include a printable area and an open area 605. In some aspects, the perforated window film 505 may include 50% printable area and 50% open area 605. The printable area may display an advertisement associated with an advertiser, and the open area 605 may allow visibility through the rear windshield 510 from inside the vehicle 500.

In some cases, the graphics installer may apply a tracking puck during installation of the perforated window film 505 on the rear windshield 510. The tracking puck may be a plastic component that emits a signal to assist the mobile application 200 in tracking mileage of the vehicle 500. The signal emitted by the tracking puck may be received by the mobile application 200 to supplement location tracking data and verify driving activity.

The driver may activate the driver account within the mobile application 200 by scanning a code or identifier associated with the perforated window film 505 or the mobile vehicle advertising system. The scanning accessibility feature may verify that the driver has received and installed the perforated window film 505 on the rear windshield 510 of the vehicle 500.

During ongoing operation, the mobile application 200 may continuously track the location of the driver relative to a designated address associated with an advertiser. The mobile application 200 may utilize global positioning system (GPS) data, cellular network data, Wi-Fi positioning data, or a combination thereof to determine the location of the driver. The mobile application 200 may monitor the location of the driver while the mobile application 200 is running on the mobile device.

The mobile application 200 may calculate total miles driven within one or more radial zones surrounding the designated address based on the tracked location of the driver. The mobile application 200 may determine when the driver enters and exits each radial zone and may accumulate mileage data for each radial zone accordingly. In some aspects, the mobile application 200 may calculate total miles within a first radial zone, total miles within a second radial zone, and total miles within a third radial zone as separate values. The first radial zone may have a first radius from the designated address, the second radial zone may have a second radius greater than the first radius, and the third radial zone may have a third radius greater than the second radius.

The mobile application 200 may calculate a payment amount based on the calculated total miles within the radial zones multiplied by predetermined rates. Different predetermined rates may apply to different radial zones. In some cases, miles driven within the first radial zone may be compensated at a higher rate than miles driven within the second radial zone, and miles driven within the second radial zone may be compensated at a higher rate than miles driven within the third radial zone. The mobile application 200 may multiply the total miles driven within each radial zone by the respective predetermined rate and sum the resulting values to calculate the total payment amount.

In some aspects, the mobile application 200 may apply boosted pay rates in designated boosted zones or heat zones. The mobile application 200 may detect when the driver enters a boosted zone and apply the boosted pay rate to miles driven within the boosted zone. The mobile application 200 may display notifications or indicators to inform the driver when the driver enters a heat zone or a boosted area.

The mobile application 200 may include a photo verification feature that prompts the driver to take a photo of the rear windshield 510 and the odometer of the vehicle 500 at a predetermined interval. The predetermined interval may include a weekly interval or a monthly interval. The photo verification feature may allow the mobile vehicle advertising system to confirm that the perforated window film 505 applied to the rear windshield 510 remains intact and presentable. The odometer photograph may provide mileage verification data that supplements location tracking information collected by the mobile application 200. The photographs captured through the photo verification feature may be transmitted to a server or backend system for review.

The mobile application 200 may display a mobile application interface comprising a dashboard. The dashboard may display mileage information, payment information, and a map indicating the designated address and associated radial zones. The dashboard may show the current location of the driver relative to the radial zones. The mobile application 200 may display heat zones indicating boosted areas where drivers may earn bonus pay for driving in those locations.

The mobile vehicle advertising system may process payments to drivers through direct deposit. The driver may link a bank account to the mobile application 200 to receive payment amounts calculated by the mobile application 200. The mobile application 200 may transmit payment information to a payment processing system that initiates direct deposit transfers to the linked bank account of the driver. The direct deposit payment processing may occur at predetermined intervals based on the accumulated payment amounts calculated from miles driven within the radial zones.

The mobile vehicle advertising system may include a company dashboard accessible to advertisers through the mobile application 200. The company dashboard may provide advertisers with tools for managing logistics associated with advertising campaigns. The company dashboard may allow advertisers to view analytics related to advertising campaign performance, including total impressions generated by vehicles displaying advertisements associated with the advertiser. The campaign information may include spent amounts, impressions data, clicks data, and cost per impression data.

In some aspects, the mobile vehicle advertising system may include a minimum monthly mileage requirement for drivers participating in advertising campaigns. The mobile vehicle advertising system may require drivers to drive a minimum of 900 miles per month to participate in the advertising program. The mobile vehicle advertising system may include a sticker commitment period during which drivers agree to display the perforated window film 505 on the rear windshield 510 of the vehicle 500 for a period ranging from 6 months to 24 months.

A number of implementations have been described. Nevertheless, it will be understood that various modifications may be made without departing from the spirit and scope of the disclosure. Accordingly, other implementations are within the scope of the following claims.

1. A system, comprising:
a vehicle comprising a rear windshield and an odometer;
a perforated window film covering an outer surface of the rear windshield, wherein the perforated window film comprises 50% printable area and 50% open area;
a mobile application configured to:
prompt a driver of the vehicle to take a photo of the rear windshield and the odometer at a predetermined interval;
continuously track a location of the driver relative to a designated address;
calculate total miles within a radial zone of the designated address based on the tracked location of the driver; and
calculate a payment amount based on the calculated total miles within the radial zone multiplied by a predetermined rate.

2. The system of claim 1, wherein the radial zone comprises a first radial zone having a first radius from the designated address.

3. The system of claim 2, further comprising a second radial zone having a second radius from the designated address, wherein the second radius is greater than the first radius.

4. The system of claim 3, further comprising a third radial zone having a third radius from the designated address, wherein the third radius is greater than the second radius.

5. The system of claim 4, wherein the mobile application is configured to calculate the payment amount based on different predetermined rates for miles driven within the first radial zone, the second radial zone, and the third radial zone.

6. The system of claim 1, wherein the mobile application is configured to display a map showing the designated address and the radial zone.

7. The system of claim 1, wherein the perforated window film comprises an advertisement printed on the printable area.

8. The system of claim 7, wherein the advertisement comprises a QR code.

9. The system of claim 1, wherein the mobile application is configured to display a mobile application interface comprising a dashboard showing mileage information and payment information.

10. The system of claim 1, wherein the predetermined interval comprises a weekly interval or a monthly interval.

11. A mobile application stored on a non-transitory computer-readable medium and executable by a processor, the mobile application configured to:
prompt a driver of a vehicle to take a photo of a rear windshield of the vehicle and an odometer of the vehicle at a predetermined interval, wherein a perforated window film covers an outer surface of the rear windshield;
continuously track a location of the driver relative to a designated address;
calculate total miles within a radial zone of the designated address based on the tracked location of the driver; and
calculate a payment amount based on the calculated total miles within the radial zone multiplied by a predetermined rate.

12. The mobile application of claim 11, wherein the radial zone comprises a first radial zone having a first radius from the designated address.

13. The mobile application of claim 12, wherein the mobile application is further configured to calculate miles within a second radial zone having a second radius from the designated address, wherein the second radius is greater than the first radius.

14. The mobile application of claim 13, wherein the mobile application is further configured to calculate miles within a third radial zone having a third radius from the designated address, wherein the third radius is greater than the second radius.

15. The mobile application of claim 11, wherein the mobile application is configured to display a map showing the designated address and the radial zone.

16. The mobile application of claim 11, wherein the mobile application is configured to display notifications comprising driving tips for the driver.

17. A method, comprising:
prompting, by a mobile application, a driver of a vehicle to take a photo of a rear windshield of the vehicle and an odometer of the vehicle at a predetermined interval, wherein a perforated window film covers an outer surface of the rear windshield, and wherein the perforated window film comprises 50% printable area and 50% open area;
continuously tracking, by the mobile application, a location of the driver relative to a designated address;
calculating, by the mobile application, total miles within a radial zone of the designated address based on the tracked location of the driver; and
calculating, by the mobile application, a payment amount based on the calculated total miles within the radial zone multiplied by a predetermined rate.

18. The method of claim 17, wherein the radial zone comprises a first radial zone having a first radius from the designated address.

19. The method of claim 18, further comprising calculating, by the mobile application, miles within a second radial zone having a second radius from the designated address, wherein the second radius is greater than the first radius.

20. The method of claim 17, further comprising displaying, by the mobile application, a mobile application interface comprising a map showing the designated address and the radial zone.
